(19) United States
(12) Patent Application Publication
(10) Pub. No.: US 2013/0073264 A1
(43) Pub. Date: Mar. 21, 2013

(54) DESIGN SUPPORT APPARATUS, DESIGN SUPPORT METHOD, AND COMPUTER-READABLE STORAGE MEDIUM STORING DESIGN SUPPORT PROGRAM

(71) Applicants: Hirooki HAYASHI, Kawasaki (JP); Hidekatsu Sasaki, Kawasaki (JP); Tsukasa Tenma, Kawasaki (JP); Ryusuke Akahoshi, Machida (JP); Mari Morimoto, Kawasaki (JP)

(72) Inventors: Hirooki HAYASHI, Kawasaki (JP); Hidekatsu Sasaki, Kawasaki (JP); Tsukasa Tenma, Kawasaki (JP); Ryusuke Akahoshi, Machida (JP); Mari Morimoto, Kawasaki (JP)

(73) Assignee: FUJITSU LIMITED, Kawasaki-shi (JP)

(21) Appl. No.: 13/610,989

(22) Filed: Sep. 12, 2012

(30) Foreign Application Priority Data
Sep. 15, 2011 (JP) 2011-201254

(51) Int. Cl. G06F 17/50

(52) U.S. Cl. 703/1

(57) ABSTRACT

A design support apparatus includes a determination unit configured to determine, using a line segment serving as a reference, start and end points of which are each defined by a relative position to a predetermined shape appearing in a cross-section of a design object for which clearance measurement is performed, a line segment satisfying a predetermined condition in relation to the line segment serving as the reference, out of line segments appearing in a cross-sectional view created based on shape data of the object, as a first line segment including a start point of a spot for clearance measurement, and an identification unit configured to identify, using a vector specifying a direction of clearance measurement, a clearance between the first line segment determined by the determination unit and a second line segment existing in a direction of the vector from the first line segment, as a measurement spot.

### CROSS-REFERENCE TO RELATED APPLICATION

This application is based upon and claims the benefit of priority of the prior Japanese Patent Application No. 2011-201254, filed on Sep. 15, 2011, the entire contents of which are incorporated herein by reference.

### FIELD

The embodiments discussed herein are related to a design support apparatus, a design support method, and a computer-readable storage medium storing a design support program.

### BACKGROUND

In designing a product using a 3D CAD (three Dimensions Computer Aided Design) or the like, it is known that a clearance between components is measured for the purpose of verifying design of a focused part of the product or like purposes. For example, there has been known a technique in which a two-dimensional pattern of a specific part of an object is stored in advance as a two-dimensionally arranged reference pattern, and a matching pattern which best matches the reference pattern is found out from partial patterns of an input two-dimensional pattern of an object for which position identification is performed, to thereby measure an identified position in the object in the input two-dimensional pattern. See, for example, Japanese Laid-Open Patent Publication No. 04-58376.

When a designer causes an apparatus based on the technique to identify a clearance which the designer desires to measure, if the apparatus is merely caused to automatically acquire a clearance which is accommodated within a certain range of distance from a surrounding structure, the apparatus identifies all clearances which are accommodated within the certain range of distance from the surrounding structure. This causes a problem that the apparatus identifies even clearances which are different from a clearance of a spot which the designer desires to measure.

### SUMMARY

According to an aspect of the invention, there is provided a design support apparatus including a processor configured to execute processing including determining, using a line segment serving as a reference end points of which are each defined by a relative position to a predetermined shape appearing in a cross-section of an object for which clearance measurement is performed, a line segment which satisfies a predetermined condition in relation to the line segment serving as the reference, out of line segments appearing in a cross-sectional view created based on shape data of the object, as a first line segment including a start point of a spot for clearance measurement, and identifying, using a vector which specifies a direction of clearance measurement, a clearance between the first line segment determined by the determining and a second line segment existing in a direction of the vector from the first line segment, as a measurement spot.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a design support apparatus according to a first embodiment;

FIG. 2 illustrates the hardware configuration of a design support apparatus according to a second embodiment;

FIG. 3 is a block diagram of functions of the design support apparatus according to the second embodiment;

FIG. 4 illustrates an example of a cross-sectional view created by a cross-sectional view creation unit;

FIG. 5 illustrates an example of a measurement spot identification pattern;

FIG. 6 is a flowchart of a process executed by the design support apparatus;

FIG. 7 is a flowchart of a first cross-sectional view creation process;

FIGS. 8A to 8D are views useful in explaining an example of the first cross-sectional view creation process;

FIGS. 9A and 9B are views useful in explaining extraction of a portion where a new plane occurs;

FIG. 10 is a flowchart of a second cross-sectional view creation process;

FIGS. 11A and 11B are views useful in explaining an example of the second cross-sectional view creation process;

FIGS. 12A and 12B are views useful in explaining the example of the second cross-sectional view creation process;

FIGS. 13A and 13B are views useful in explaining a method of determining a rotational angle;

FIG. 14 is a flowchart of a measurement spot identification process;

FIG. 15 is a view useful in explaining an example of the measurement spot identification process;

FIGS. 16A and 16B are views useful in explaining the example of the measurement spot identification process;

FIGS. 17A and 17B are views useful in explaining the example of the measurement spot identification process;

FIGS. 18A to 18C are views useful in explaining the example of the measurement spot identification process;

FIG. 19 is a view useful in explaining the example of the measurement spot identification process;

FIG. 20 illustrates an example of a measurement result output from an output unit;

FIG. 21 is a view useful in explaining another example of the measurement spot identification process;

FIG. 22 is a view useful in explaining still another example of the measurement spot identification process;

FIG. 23 is a flowchart of a measurement spot identification process according to a third embodiment;

FIG. 24 is a view useful in explaining an example of the measurement spot identification process according to the third embodiment;

FIG. 25 is a view useful in explaining the example of the measurement spot identification process according to the third embodiment;

FIG. 26 is a view useful in explaining the example of the measurement spot identification process according to the third embodiment;

FIG. 27 is a view useful in explaining the example of the measurement spot identification process according to the third embodiment;

FIGS. 28A and 28B are views useful in explaining an example of the measurement spot identification process according to the third embodiment;

FIGS. 29A and 29B are views useful in explaining the example of the measurement spot identification process according to the third embodiment; and

FIG. 30 is a view useful in explaining the example of the measurement spot identification process according to the third embodiment.

### DESCRIPTION OF EMBODIMENTS

Several embodiments will be described below with reference to the accompanying drawings, wherein like reference numerals refer to like elements throughout.

### (a) First Embodiment

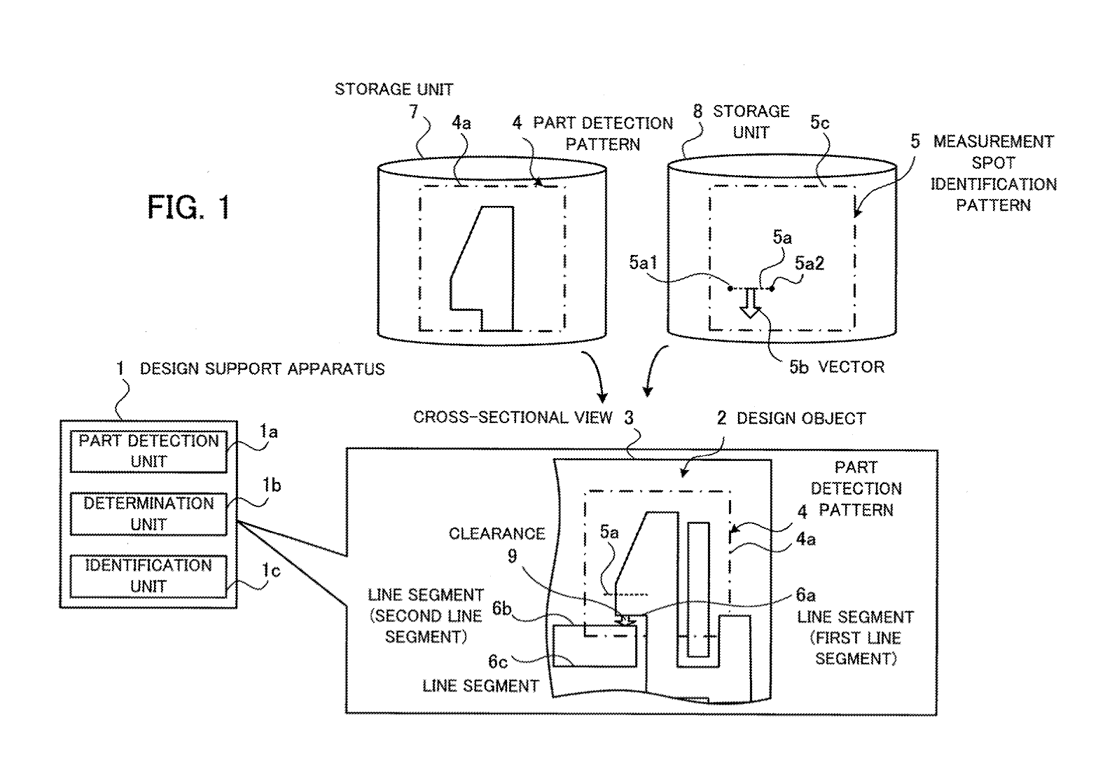

FIG. 1 illustrates a design support apparatus according to a first embodiment. The design support apparatus (computer), denoted by reference numeral 1, illustrated in FIG. 1 is an apparatus equipped with a function for measuring a clearance in a design object, such as a manufactured product. FIG. 1 illustrates a cross-sectional view 3 of a design object 2 for which clearance measurement is performed. The cross-sectional view 3 is created from a 3D model or the like of the design object 2, which is created using e.g. a CAD.

The design support apparatus 1 includes a part detection unit 1a, a determination unit 1b, and an identification unit 1c.

The part detection unit 1a detects a part having a predetermined shape in the cross-sectional view 3 using a part detection pattern 4 selected by a designer. One or a plurality of part detection pattern(s) 4 is or are stored in a storage unit 7, and for example, the designer is enabled to select one part detection pattern 4 from the plurality of part detection patterns 4 according to a part which the designer desires to detect.

The determination unit 1b and the identification unit 1c identify a spot of the design object 2 for clearance measurement (measurement spot) using a measurement spot identification pattern 5, from the part in the cross-sectional view 3 detected by the part detection unit 1a. One or a plurality of measurement spot identification pattern(s) 5 is or are stored in a storage unit 8. Although which of the measurement spot identification patterns 5 is to be used is not specifically limited, for example, a correspondence relationship between the measurement spot identification pattern 5 and the part detection pattern 4 may be set in advance, and the design support apparatus 1 may read the measurement spot identification pattern 5 corresponding to the part detection pattern 4. Further, the designer may select one measurement spot identification pattern from the plurality of measurement spot identification patterns and cause the design support apparatus 1 to read the selected measurement spot identification pattern 5.

The identification unit 1c measures the identified measurement spot, and displays the measurement result on a monitor, not illustrated. The measurement spot identification pattern 5 includes a line segment 5a serving as a reference, end points of which are each defined by a relative position to a predetermined shape appearing in a cross-section of the design object 2, and a vector 5b which specifies a direction of clearance measurement. Position coordinates of a start point 5a1 and position coordinates of an end point 5a2 are set for the line segment 5a. In FIG. 1, an outer frame 4a of the part detection pattern 4 and an outer frame 5c of the measurement spot identification pattern 5 are formed to be equal in size. Hereinafter, a description will be given of processing executed by the determination unit 1b and the identification unit 1c, for identifying a measurement spot.

First, the determination unit 1b determines, for the cross-sectional view 3, out of line segments appearing in the cross-sectional view created based on shape data of the design object 2 using the line segment 5a, a line segment which satisfies a predetermined condition in relation to the line segment 5a, as a first line segment including a start point of a measurement spot for clearance measurement. More specifically, the determination unit 1b sequentially extracts a predetermined number of line segments of the design object 2 using the position coordinates of the line segment 5a, in an increasing order of distance from the line segment 5a. The line segments are extracted using e.g. a method in which an extraction range is concentrically increased from a center point of the line segment 5a, thereby extracting central coordinates of each line segment occurring within the extraction range, and when the number of the central coordinates of the extracted line segments reaches the predetermined number, the extraction is terminated. Further, there is another extraction method in which a concentric circle located at a predetermined distance from the center point of the line segment 5a is virtually set, thereby extracting line segments each having central coordinates within the set concentric circle. In FIG. 1, it is assumed that the determination unit 1b has extracted a line segment 6a and a line segment 6b.

The determination unit 1b determines one of the extracted line segments 6a and 6b, which has the smallest difference in slope from the line segment 5a, as the first line segment. In FIG. 1, it is assumed that the line segments 6a and 6b are equal (0°) in difference of slope from the line segment 5a. In this case, the determination unit 1b determines the line segment 6a which is shortest in distance from the line segment 5a as the first line segment. Hereinafter, the line segment 6a is referred to as the “first line segment 6a”.

The identification unit 1c uses the vector 5b to thereby determine a second line segment existing in a direction of the vector 5b from the first line segment 6a determined by the determination unit 1b. Then, the identification unit 1c measures a clearance 9 between the first line segment 6a and the determined second line segment. More specifically, the identification unit 1c detects the line segment 6b and a line segment 6c existing in the direction of the vector 5b of the first line segment 6a. Since the plurality of line segments 6b and 6c exist in the direction of the vector 5b, the identification unit 1c determines the line segment 6b which is shortest in length of all perpendicular lines extending from vertexes of the line segments 6b and 6c to the first line segment 6a, as the second line segment. Although not illustrated, if only one line segment exists in the direction of the vector 5b, the identification unit 1c determines the detected one line segment as the second line segment. The identification unit 1c displays the measurement result on the monitor, not illustrated.

According to the design support apparatus 1, it is possible to identify the clearance 9 to be measured, according to the measurement spot identification pattern 5.

The part detection unit 1a, the determination unit 1b, and the identification unit 1c may be realized by functions provided in a CPU (Central Processing Unit) included in the design support apparatus 1. The storage units 7 and 8 may be realized by a data storage area included e.g. in a RAM (Random Access Memory) or a hard disk drive (HDD).

Hereinafter, in a second embodiment, the disclosed design support apparatus will be more specifically described.

### (b) Second Embodiment

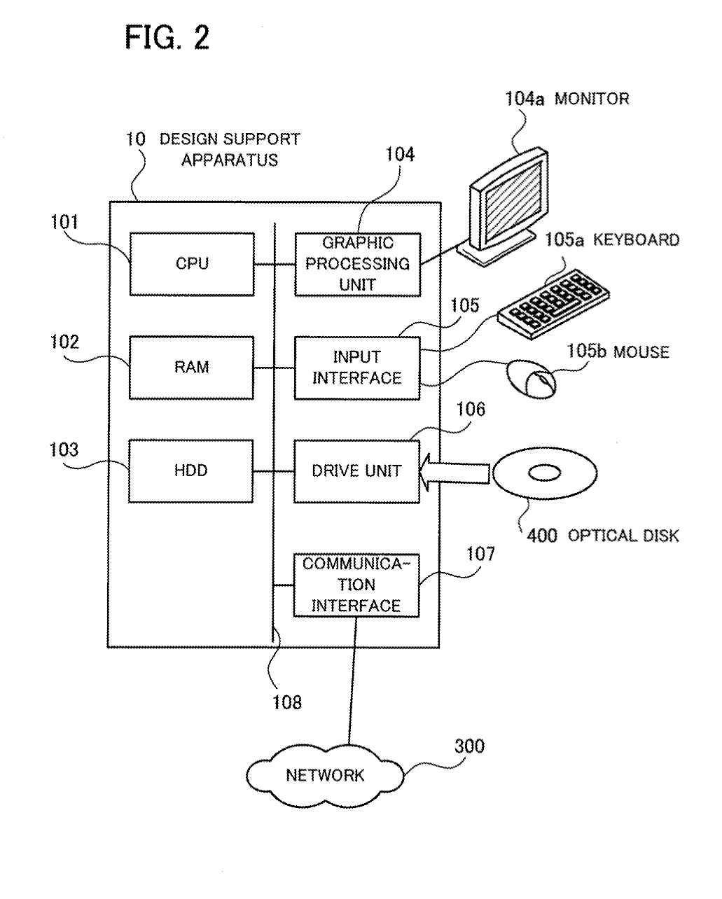

FIG. 2 illustrates the hardware configuration of the design support apparatus according to the second embodiment. The overall operation of the design support apparatus, denoted by reference numeral 10, is controlled by a CPU 101. A RAM 102 and a plurality of peripheral devices are connected to the CPU 101 via a bus 108.

The RAM 102 is used as a main storage device of the design support apparatus 10. The RAM 102 temporarily stores at least part of a program of an OS (Operating System) and application programs which the CPU 101 is caused to execute. Further, the RAM 102 stores various data used for processing by the CPU 101.

A hard disk drive 103, a graphic processing unit 104, an input interface 105, a drive unit 106, and a communication interface 107 are connected to the bus 108.

The hard disk drive 103 magnetically writes and reads out data into and from a disk incorporated therein. The hard disk drive 103 is used as a secondary storage device of the design support apparatus 10. The hard disk drive 103 stores the program of the OS, the application programs, and various data. Note that a semiconductor storage device, such as a flash memory, may be used as the secondary storage device.

A monitor 104a is connected to the graphic processing unit 104. The graphic processing unit 104 displays images on a screen of the monitor 104a according to commands from the CPU 101. The monitor 104a may be a display device using a CRT (Cathode Ray Tube) or a liquid crystal display device, for example.

A keyboard 105a and a mouse 105b are connected to the input interface 105. The input interface 105 transmits signals delivered from the keyboard 105a or the mouse 105b to the CPU 101. The mouse 105b is an example of a pointing device, and any other suitable type of pointing device may be used. The other suitable types of the pointing device include a touch panel, a tablet, a touch pad, a track ball, and so forth.

The drive unit 106 reads out data recorded in a transportable storage medium, such as an optical disk on which data is recorded in a manner readable by reflection of light and a USB (Universal Serial Bus) memory. For example, when the drive unit 106 is an optical drive unit, the drive unit 106 reads out data recorded in an optical disk 400 using e.g. a laser light. Examples of the optical disk 400 include a Blu-ray (registered trademark), a DVD (Digital Versatile Disc), a DVD-RAM, a CD-ROM (Compact Disc Read Only Memory), and a CD-R (Recordable)/RW (ReWritable).

The communication interface 107 is connected to a network 300. The communication interface 107 exchanges data with other computers or communication devices via the network 300.

With the hardware configuration described above, it is possible to realize processing functions of the present embodiment.

The design support apparatus 10 having the hardware configuration as illustrated in FIG. 2 is equipped with functions described hereafter.

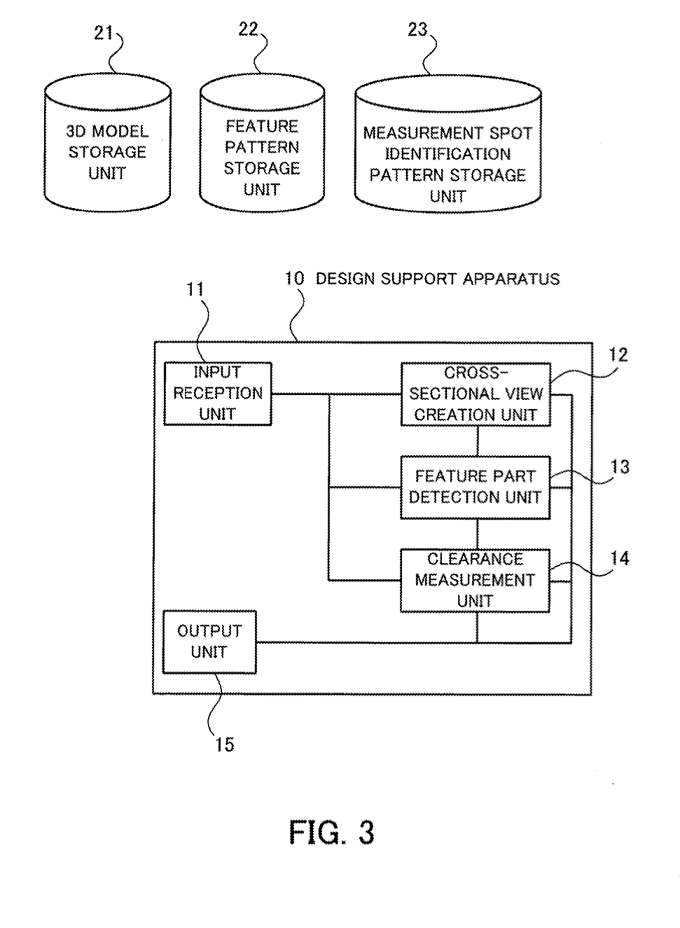

FIG. 3 is a block diagram of the functions of the design support apparatus according to the second embodiment. The design support apparatus 10 includes an input reception unit 11, a cross-sectional view creation unit 12, a feature part detection unit 13, a clearance measurement unit 14, and an output unit 15. The feature part detection unit 13 is an example of the part detection unit. The clearance measurement unit 14 and the output unit 15 are an example of the determination unit and the identification unit.

The input reception unit 11 receives inputs of a 3D model of a product, which is stored in a 3D model storage unit 21, a feature pattern stored in a feature pattern storage unit 22, and a measurement spot identification pattern stored in a measurement spot identification pattern storage unit 23.

The feature pattern is a pattern used for detecting a part of the 3D model which is designated by the designer as a part having a feature. The designer may register a general shape of a part where the designer desires to perform clearance measurement, as a feature pattern, in the feature pattern storage unit 22.

The measurement spot identification pattern is a pattern used for identifying a measurement spot of a 3D model. Although details will be described hereinafter, by using the measurement spot identification pattern in combination with the feature pattern, the design support apparatus 10 makes it possible to increase possibility of more positively identifying a measurement spot where the designer desires to perform clearance measurement.

When the 3D model, the feature pattern, and the measurement spot identification pattern each exist in plurality, the designer may determine the 3D model, the feature pattern, and the measurement spot identification pattern, which are to be used, as desired.

Then, the input reception unit 1 sends the received 3D model to the cross-sectional view creation unit 12, the received feature pattern to the feature part detection unit 13, and the received measurement spot identification pattern to the clearance measurement unit 14.

Note that one or all of the 3D model storage unit 21, the feature pattern storage unit 22, and the measurement spot identification pattern storage unit 23 may be provided in the design support apparatus 10.

The cross-sectional view creation unit 12 creates a cross-sectional view of the product based on the 3D model received by the input reception unit 11. More specifically, the cross-sectional view creation unit 12 creates the cross-sectional views obtained by slicing the 3D model in directions X, Y, and Z, respectively, at equally-spaced intervals based on the 3D model in a 3D coordinate system. Each created cross-sectional view is formed by a plurality of line segments.

The feature part detection unit 13 detects an approximate location of a characteristic part (hereinafter referred to as the “feature part”) using the cross-sectional view created by the cross-sectional view creation unit 12 and the feature pattern received by the input reception unit 11. Note that for example, as the feature part, out of parts existing around a portion where clearance measurement is desired to be performed, a part having a characteristic cross-section is used. The characteristic cross-section is e.g. a cross-section as to which it is known that no other cross-section having the same shape as the characteristic cross-section appears in the cross-sectional view. Further, it is possible to use, as the feature part, even a part at a location distant from where clearance measurement is desired to be performed insofar as a relative position of a portion where clearance measurement is desired to be performed to the part is definite. The feature part is detected using e.g. a conventionally known pattern matching method (e.g. graph matching). Note that the feature part detection unit 13 may be configured to detect a part which is completely matched with the feature pattern, or may be configured to detect a part which is partially matched with the feature part.

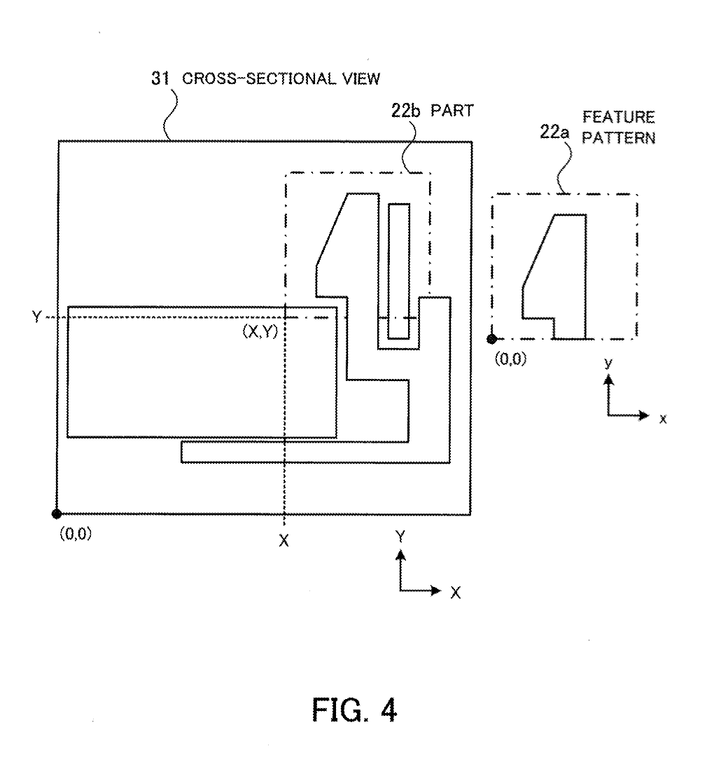

FIG. 4 illustrates an example of a cross-sectional view created by the cross-sectional view creation unit.

A cross-sectional view 31 illustrated in FIG. 4 is one of a plurality of cross-sectional views created by the cross-sectional view creation unit 12 in a Z-axis direction of the 3D model. FIG. 4 illustrates a part 22b which is detected on the cross-sectional view 31 as a part matched with a feature pattern 22a. The coordinates (X,Y) of the lower left corner of the part 22b on the cross-sectional view 31 employing the X-Y coordinate system correspond to the coordinates (0,0) of the origin of the feature pattern 22a employing the x-y coordinate system.

The clearance measurement unit 14 identifies a spot for clearance measurement, from the part 22b on the cross-sectional view 31 of the product, using the measurement spot identification pattern received by the input reception unit 11. Then, the clearance measurement unit 14 performs clearance measurement of the identified spot.

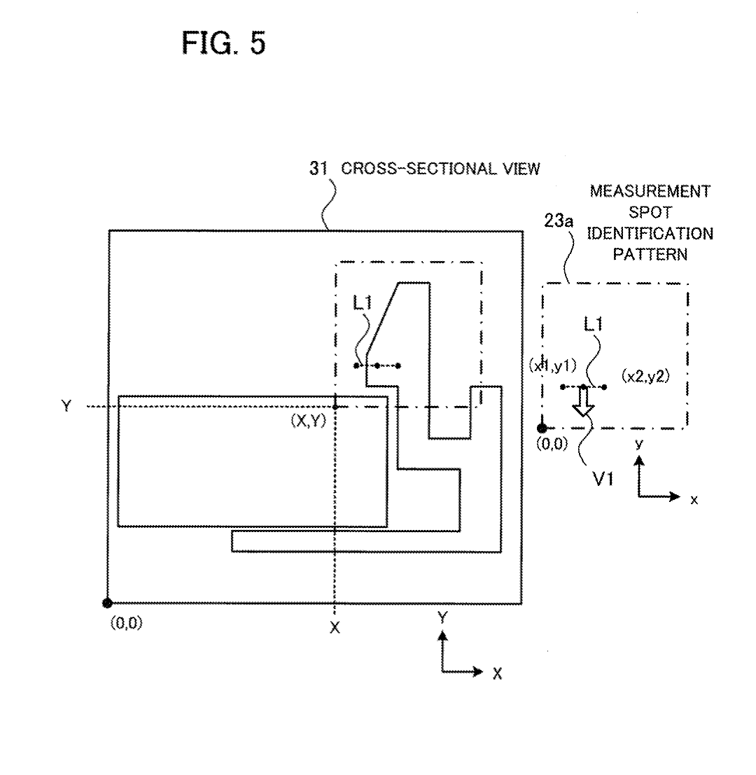

FIG. 5 illustrates an example of the measurement spot identification pattern.

A measurement spot identification pattern 23a includes a line segment L1 serving as a reference for identifying a spot for clearance measurement, and a unit vector V1 for specifying a measurement direction. In FIG. 5, the direction of the unit vector V1 is a direction perpendicular to the line segment L1. The x-y coordinate system is employed as a coordinate system of the measurement spot identification pattern 23a, and corresponds to the coordinate system of the feature pattern 22a. For example, the coordinates (0,0) of the origin of the measurement spot identification pattern 23a correspond to the coordinates (0,0) of the origin of the feature pattern 22a. In the present embodiment, the coordinates of opposite ends of the line segment L1 in the measurement spot identification pattern 23a are set to (x1, y1) and (x2, y2), respectively. In the present embodiment, the designer has registered the feature patterns 22a and the measurement spot identification patterns 23a in the measurement spot identification pattern storage unit 23 in a manner associated with each other on a one-to-one basis. That is, the measurement spot identification pattern 23a in the present embodiment is a pattern specialized for identifying a spot for clearance measurement on a part detected by the feature pattern 22a. By associating the feature patterns 22a and the measurement spot identification patterns 23a with each other on a one-to-one basis as above, and causing the input reception unit to receive inputs thereof for identification, it is possible to increase the accuracy of identifying a measurement spot desired by the designer. However, this is not limitative, and the feature patterns 22a and the measurement spot identification patterns 23a need not be associated with each other on a one-to-one basis. It is also possible to set the respective numbers of the feature patterns 22a and the measurement spot identification patterns 23a received by the input reception unit 11, as desired.

The output unit 15 outputs a clearance measured by the clearance measurement unit 14.

Next, a description will be given of a process executed by the design support apparatus 10.

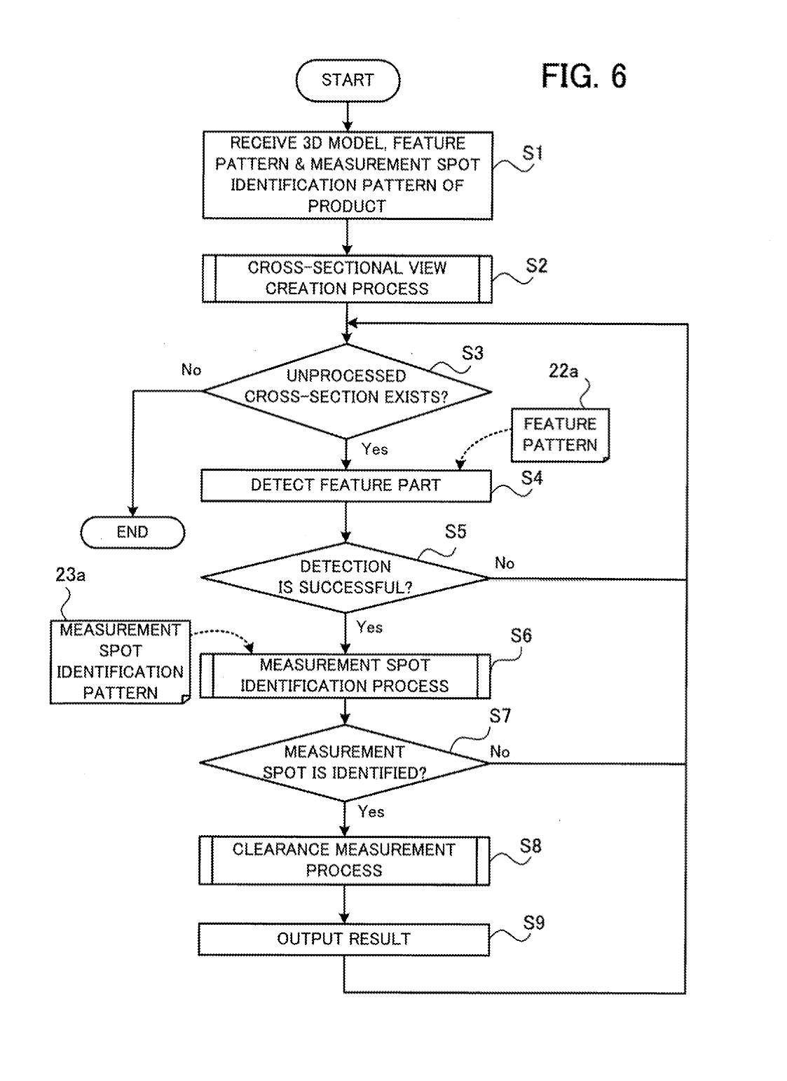

FIG. 6 is a flowchart of the process executed by the design support apparatus.

[Step S1] The input reception unit 11 receives the 3D model, the feature pattern 22a, and the measurement spot identification pattern 23a of the product. Then, the input reception unit 11 sends the received 3D model to the cross-sectional view creation unit 12, the received feature pattern 22a to the feature part detection unit 13, and the received measurement spot identification pattern 23a to the clearance measurement unit 14. Then, the process proceeds to a step S2.

[Step S2] The cross-sectional view creation unit 12 executes a cross-sectional view creation process for creating a cross-sectional view based on the received 3D model. Details of the cross-sectional view creation process will be described hereinafter.

[Step S3] The cross-sectional view creation unit 12 determines whether or not any unprocessed cross-sectional view (on which steps S4 to S9, referred to hereinafter, have not been executed) exists. If it is determined that any unprocessed cross-sectional view exists (Yes to the step S3), the cross-sectional view creation unit 12 selects one of the unprocessed cross-sectional views, and sends the selected unprocessed cross-sectional view to the feature part detection unit 13. Then, the process proceeds to a step S4. If it is determined that no unprocessed cross-sectional view exists (No to the step S3), the process in FIG. 6 is terminated.

[Step S4] The feature part detection unit 13 executes a feature part detection process for detecting a feature part using the feature pattern 22a received in the step S1, from the cross-sectional view selected by the cross-sectional view creation unit 12. After the feature part detection process is terminated, the process proceeds to a step S5.

[Step S5] The feature part detection unit 13 determines whether or not the feature part has been detected by execution of the feature part detection process. If the feature part has been detected by execution of the feature part detection process (Yes to the step S5), the feature part detection unit 13 sends the cross-sectional view received in the step S3 and the coordinates of the detected feature part to the clearance measurement unit 14. Then, the process proceeds to a step S6. If the feature part has not been detected by execution of the feature part detection process (No to the step S5), the process returns to the step S3.

[Step S6] The clearance measurement unit 14 executes a measurement spot identification process for identifying a spot for clearance measurement from the cross-sectional view of the product using the measurement spot identification pattern 23a received by the input reception unit 11. Details of the measurement spot identification process will be described hereinafter. After the measurement spot identification process is terminated, the process proceeds to a step S7.

[Step S7] The clearance measurement unit 14 determines whether or not the measurement spot has been identified by execution of the measurement spot identification process. If the measurement spot has been identified (Yes to the step S7), the process proceeds to a step S8. If the measurement spot has not been identified (No to the step S7), the process returns to the step S3.

[Step S8] The clearance measurement unit 14 executes a clearance measurement process for measuring a clearance of the measurement spot identified in the step S7. After the clearance measurement process is terminated, the process proceeds to a step S9.

[Step S9] The output unit 15 outputs the result of measurement received from the clearance measurement unit 14. Then, the process proceeds to the step S3.

This terminates the description of the process in FIG. 6.

Next, a description will be given of the cross-sectional view creation process in the step S2. The designer selects one of a process for forming a cross-section in the Z-axis direction (first cross-sectional view creation process) as illustrated in FIG. 5, and a process for forming a cross-section in a rotational direction (second cross-sectional view creation process), and causes the cross-sectional view creation unit 12 to execute the selected process. Hereinafter, the first and second cross-sectional view creation processes will be sequentially described.

<First Cross-Sectional View Creation Process>

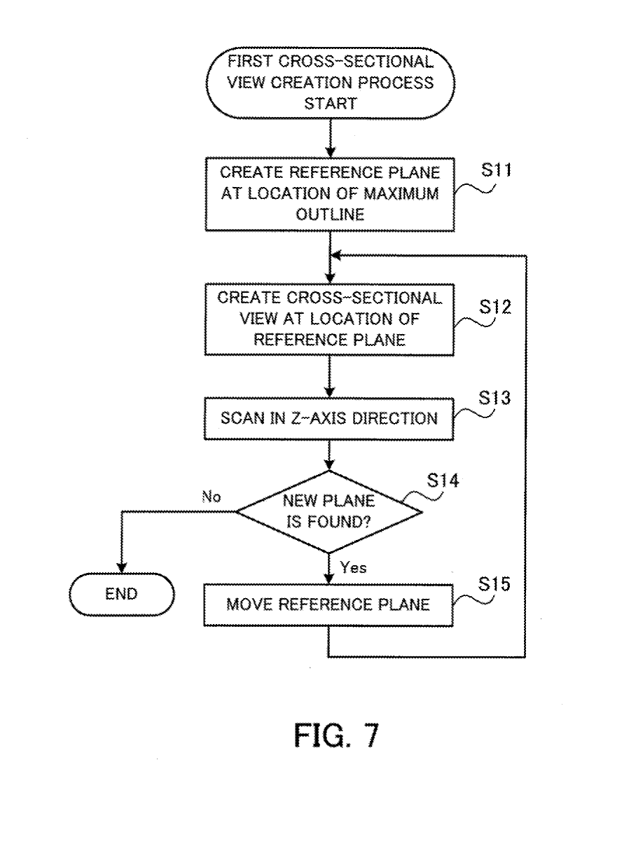

FIG. 7 is a flowchart of the first cross-sectional view creation process.

[Step S11] The cross-sectional view creation unit 12 creates a reference plane at a maximum outline position (start point in the Z-axis direction). Then, the process proceeds to a step S12.

[Step S12] The cross-sectional view creation unit 12 creates a cross-sectional view at a location where the reference plane exists. Then, the process proceeds to a step S13.

[Step S13] The cross-sectional view creation unit 12 scans in the Z-axis direction. Then, the process proceeds to a step S14.

[Step S14] The cross-sectional view creation unit 12 determines whether or not a new surface has been found. If a new surface has been found (Yes to the step S14), the process proceeds to a step S15. If no new surface has been found (No to the step S14), the process in FIG. 7 is terminated.

[Step S15] The cross-sectional view creation unit 12 moves the reference plane to the new surface. Then, the process returns to the step S12.

This terminates the description of the first cross-sectional view creation process. According to the first cross-sectional view creation process, it is possible to prevent the same cross-sectional view from being created, and narrow down the number of created cross-sectional views.

Next, an example of the first cross-sectional view creation process will be described.

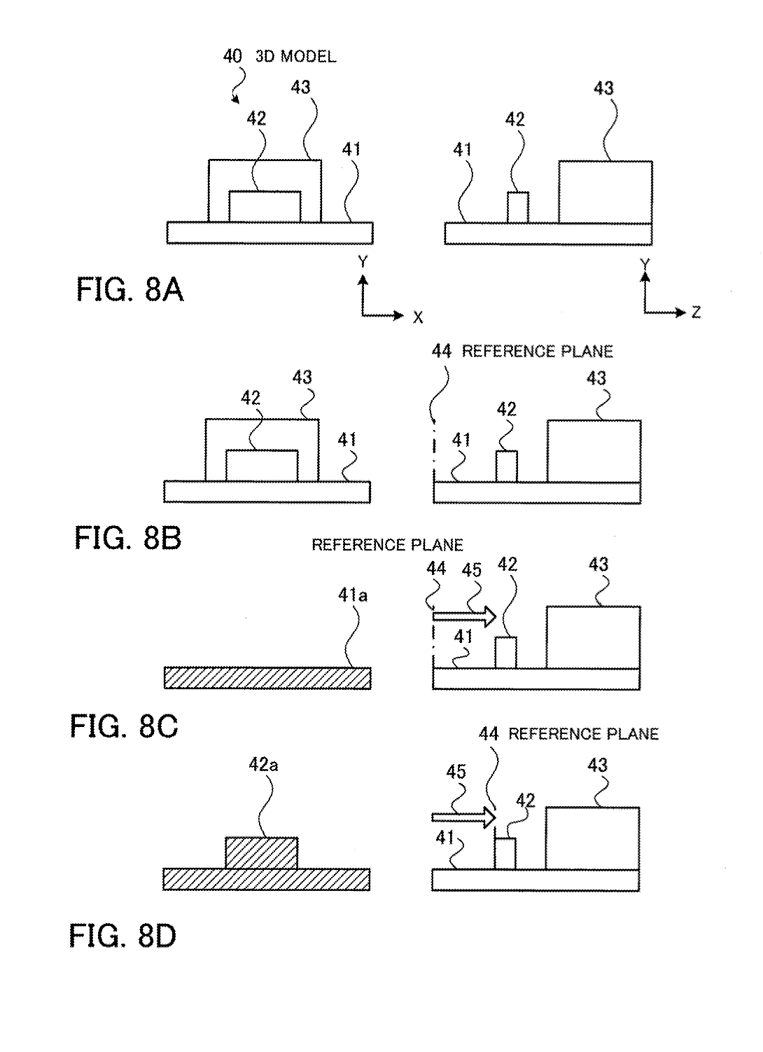

FIGS. 8A to 8D are views useful in explaining the example of the first cross-sectional view creation process.

Left figures in FIGS. 8A and 8B each illustrate a front view of a 3D model 40 when the Z-axis direction is set to a direction of depth, and right figures in FIGS. 8A and 8B each illustrate a side view of the 3D model 40. The 3D model 40 includes components 41, 42, and 43. The components 41, 42, and 43 are each formed by polygons (triangles). In the illustrated example, each polygon is a triangle formed by dividing a rectangular shape associated therewith by a diagonal line of the rectangular shape.

As illustrated in FIG. 8B, the cross-sectional view creation unit 12 creates a reference plane 44 at the maximum outline position of the component 41 included in the 3D model 40.

Next, as illustrated in FIG. 8C, the cross-sectional view creation unit 12 creates a cross-sectional view 41a of the 3D model 40 at the position of the reference plane 44.

Next, as illustrated in FIG. 8C, the cross-sectional view creation unit 12 scans the 3D model 40 in the 3D space in the Z-axis direction (see an arrow 45) from the reference plane 44, and extracts a part where a new surface occurs. In the illustrated example, a side surface of the component 42 occurs.

Next, as illustrated in FIG. 8D, the cross-sectional view creation unit 12 moves the reference plane to the side surface of the component 42. Then, the cross-sectional view creation unit 12 creates a cross-sectional view 42a of the 3D model 40 at the position of the reference plane 44.

Thereafter, although not illustrated, when a side surface of the component 43 occurs, the cross-sectional view creation unit 12 moves the reference plane to the side surface of the component 43. Then, the cross-sectional view creation unit 12 creates a cross-sectional view of the 3D model 40 at the position of the reference plane 44.

Next, the process in FIG. 8C will be described in more detail.

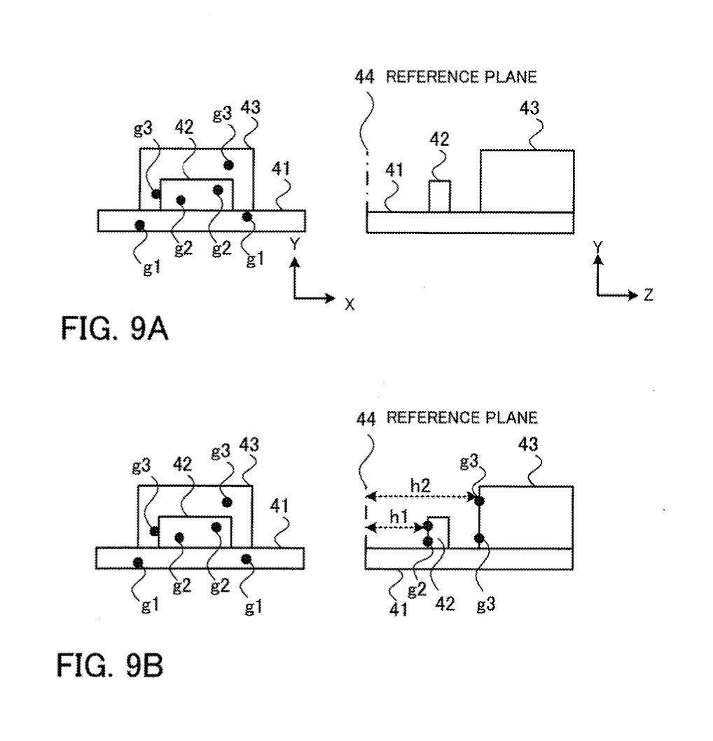

FIGS. 9A and 9B are views useful in explaining extraction of a part where a new surface occurs.

The cross-sectional view creation unit 12 determines the center of gravity of each polygon which faces in the same direction as that of the reference plane 44. FIG. 9A illustrates the determined center of gravity. Here, a center of gravity g1 is the center of gravity of each of polygons (triangles) formed from the component 41, a center of gravity g2 is the center of gravity of each of polygons (triangles) formed from the component 42, and a center of gravity g3 is the center of gravity of each of polygons (triangles) formed from the component 43.

Next, as illustrated in FIG. 9B, the cross-sectional view creation unit 12 measures distances h1 and h2 from the reference plane 44 to the centers of gravity g2 and g3, respectively, and set the surface of the component 42 having the smallest distance h1, as a new surface in the direction of depth. In determining a new surface, the other center of gravity existing on the same plane may be ignored.

<Second Cross-Sectional View Creation Process>

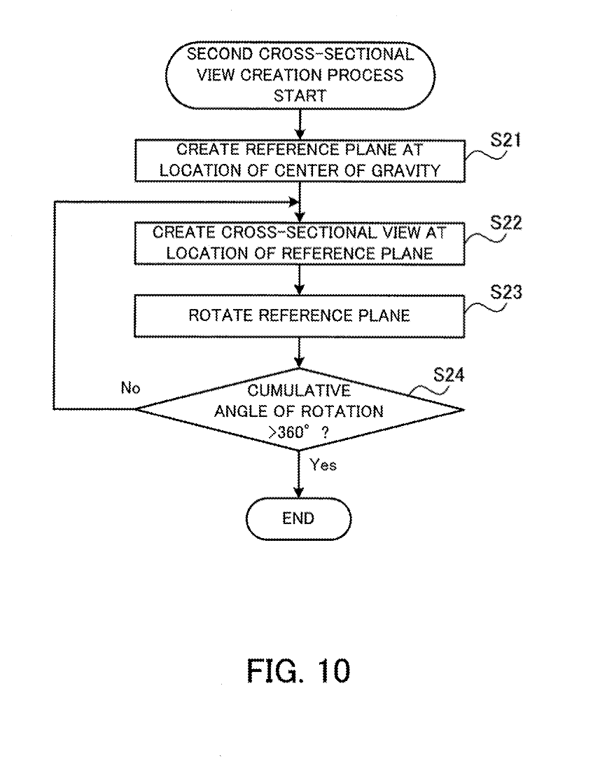

FIG. 10 is a flowchart of the second cross-sectional view creation process

[Step S21] The cross-sectional view creation unit 12 creates a reference plane which passes through the position of the center of gravity of the 3D model and is parallel to a Y-Z plane. Then, the process proceeds to a step S22.

[Step S22] The cross-sectional view creation unit 12 creates a cross-sectional view at a location where the reference plane exists. Then, the process proceeds to a step S23.

[Step S23] The cross-sectional view creation unit 12 rotates the reference plane about the Y axis. Then, the process proceeds to a step S24.

[Step S24] The cross-sectional view creation unit 12 determines whether or not a cumulative angle of rotation is larger than 360°. If the cumulative angle of rotation is larger than 360° (Yes to the step S24), the process in FIG. 10 is terminated. If the cumulative angle of rotation is not larger than 360° (No to the step S24), the process returns to the step S22.

Next, an example of the second cross-sectional view creation process will be described.

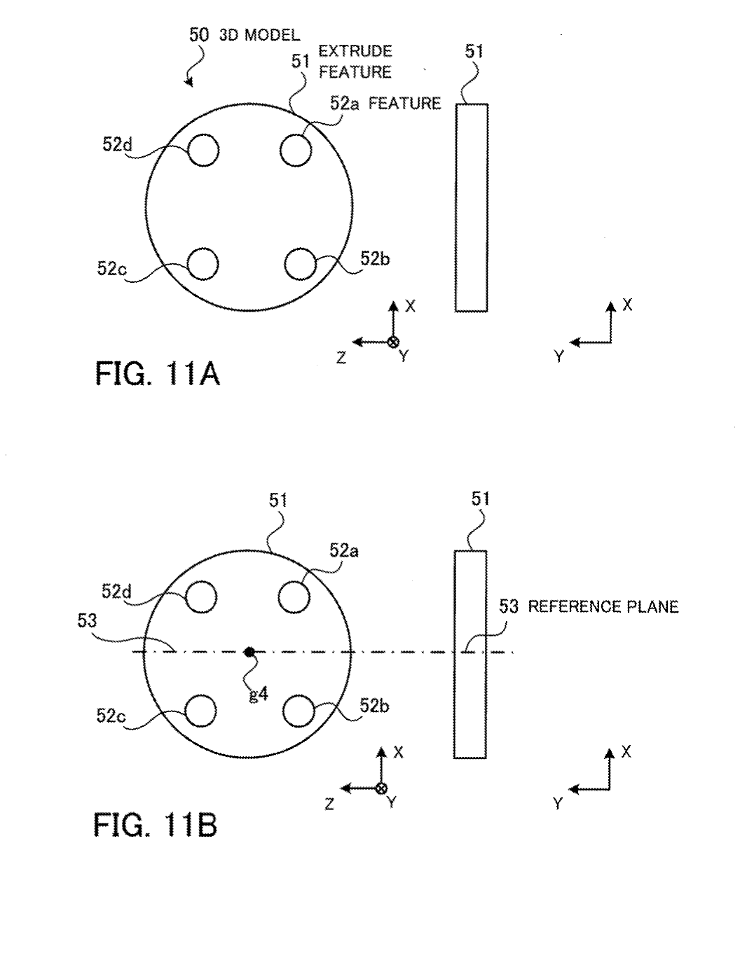

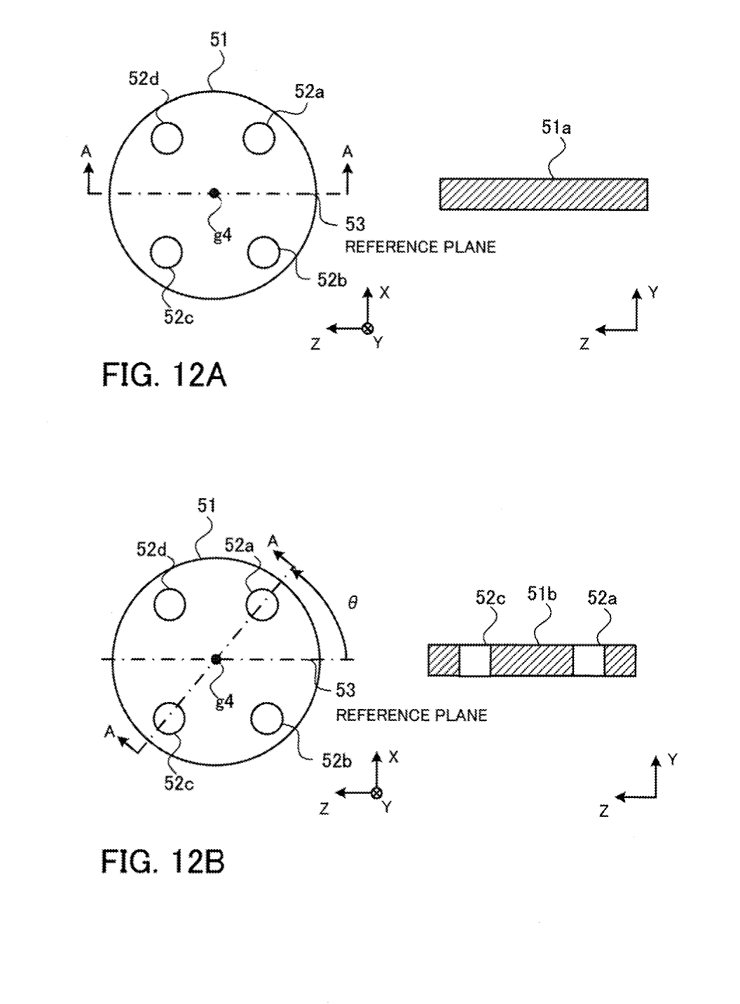

FIGS. 11A and 11B, and FIGS. 12A and 12B are views useful in explaining the example of the second cross-sectional view creation process.

Left figures in FIGS. 11A and 11B each illustrate a top view of a 3D model 50, and right figures in FIGS. 11A and 11B each illustrate a side view of the 3D model 50. The 3D model 50 includes an extrude feature 51 and features 52a to 52d. The feature is a minimum unit of configuration component elements, such as a hole, a rib, a boss, and a fillet, which are used for creating a shape using the CAD.

The cross-sectional view creation unit 12 creates a reference plane 53 which passes through a center of gravity g4 of the extrude feature 51 and is parallel to the Y-Z plane.

Next, the cross-sectional view creation unit 12 creates a cross-sectional view 51a taken along A-A on the reference plane 53, as illustrated in FIG. 12A.

Next, the cross-sectional view creation unit 12 rotates the reference plane 53 about the Y-axis on the center of gravity g4 through an angle θ, as illustrated in FIG. 12B. By execution of this processing, it becomes possible to create a cross-sectional view 51b.

Next, a description will be given of a method of determining the rotational angle θ.

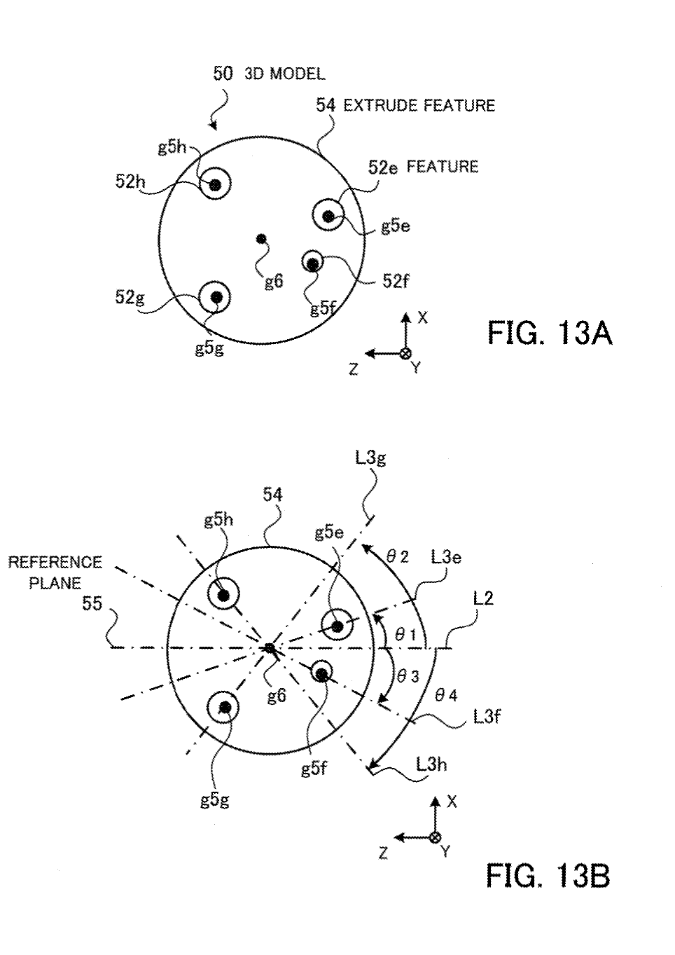

FIGS. 13A and 13B are views useful in explaining the method of determining the rotational angle.

The 3D model 50 illustrated in FIGS. 13A and 13B includes an extrude feature 54 and features 52e to 52h. The cross-sectional view creation unit 12 determines centers of gravity g5e to g5h of the features 52e to 52h, respectively. The features 52e to 52h each have a 3D form, and the centers of gravity g5e to g5h are generally determined by calculation.

The cross-sectional view creation unit 12 creates a reference plane 55 which passes through a center of gravity g6 of the extrude feature 54 and is parallel to the Y-Z plane. Further, the cross-sectional view creation unit 12 creates straight lines L3e to L3h which connect the center of gravity g6 of the extrude feature 54 and the centers of gravity g5e to g5h of the features 52e to 52h, respectively. Then, the cross-sectional view creation unit determines angles θ1 to θ4 formed between a straight line L2 of the reference plane 55 and the straight lines L3e to L3h, respectively, as the rotational angle θ. By execution of this processing, it is possible to increase possibility of obtaining an appropriate cross section for clearance measurement.

Next, a description will be given of the measurement spot identification process in the step S6.

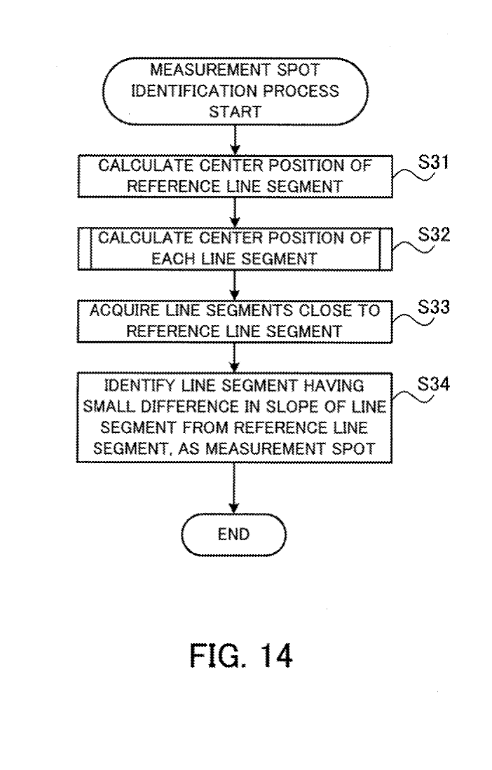

FIG. 14 is a flowchart of the measurement spot identification process.

[Step S31] The clearance measurement unit 14 calculates the center position of a line segment serving as a reference on the cross-sectional view, from the coordinates of a feature part on the cross-sectional view which is matched with the feature pattern. Then, the process proceeds to a step S32.

[Step S32] The clearance measurement unit 14 calculates the center position of each of line segments forming the cross-sectional view. Then, the process proceeds to a step S33.

[Step S33] The clearance measurement unit 14 acquires line segments which are close to the line segment serving as the reference. Then, the process proceeds to a step S34.

[Step S34] The clearance measurement unit 14 identifies a line segment having a small difference in slope from the line segment serving as the reference, as one defining the measurement spot. Then, the process in FIG. 14 is terminated.

Next, an example of the measurement spot identification process will be described.

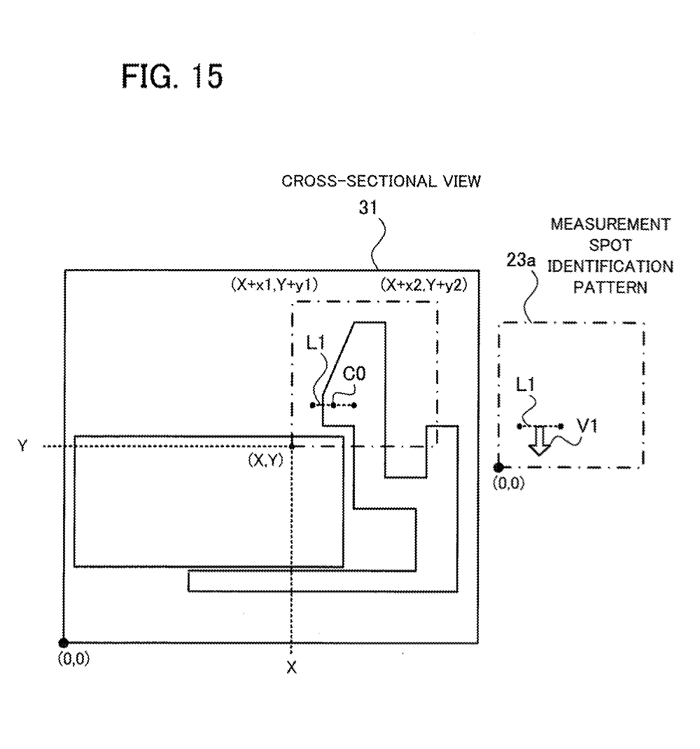

FIGS. 15 to 19 are views useful in explaining the example of the measurement spot identification process.

The clearance measurement unit 14 calculates central coordinates C0 of the line segment L1 serving as the reference on the cross-sectional view 31 from the coordinates (X,Y) on the X-Y coordinate system which correspond to the origin (0,0) of the feature pattern 22a with which a feature part on the cross-sectional view 31 is matched. More specifically, assuming that the coordinates of the left end and the right end of the line segment L1 on the x-y coordinate system are (x1, y1) and (x2, y2), respectively, the coordinates of the left end and the right end of the line segment L1 on the X-Y coordinate system are (X+x1, Y+y1) and (X+x2, Y+y2), respectively. Therefore, the center coordinates C0 are expressed by (X+(x1+x2)/2, Y+(y1+y2)/2).

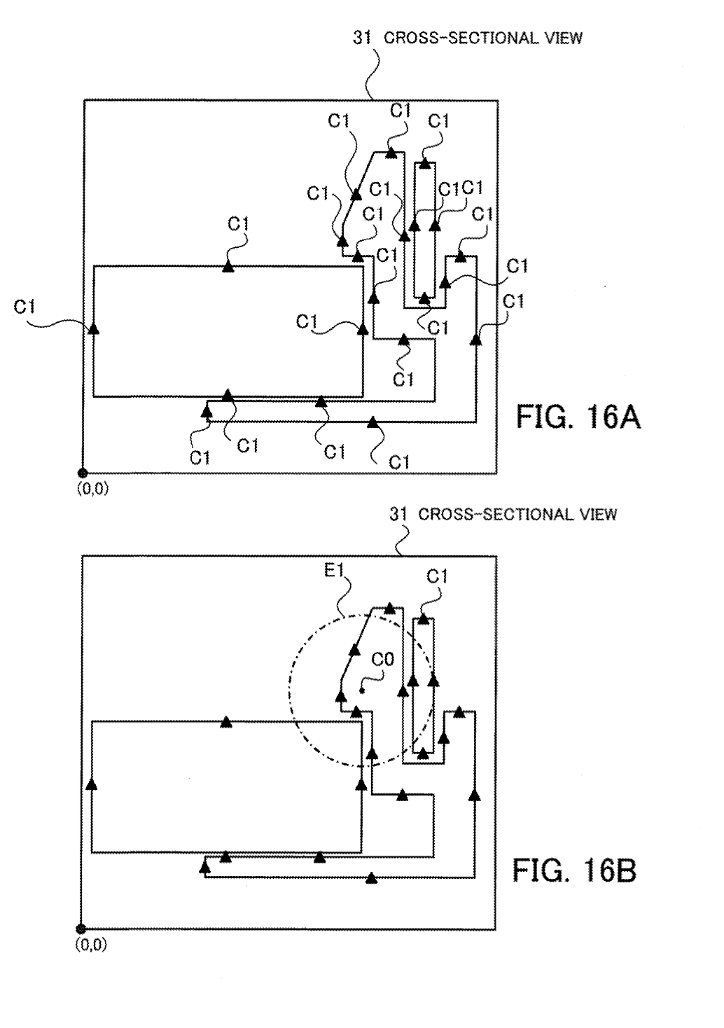

Next, as illustrated in FIG. 16A, the clearance measurement unit 14 calculates center coordinates C1 of each line segment forming the cross-sectional view 31.

Next, the clearance measurement unit 14 compares a distance between the center coordinates C0 and the center coordinates C1 of each of line segments forming the cross-sectional view 31. Then, the clearance measurement unit 14 sequentially extracts ten line segments each including the center coordinates C1, in the order of increasing distance from the center coordinates C0. More specifically, as illustrated in FIG. 16B, a search range E1 around the center coordinates C0 is concentrically increased. Then, ten center coordinates C1 are sequentially extracted, in the order of entrance to the search range E1. Note that the number of ten is given only by way of example.

Next, the clearance measurement unit 14 compares the slope of each of the extracted ten line segments and the slope of the line segment L1. Then, the clearance measurement unit 14 determines a line segment L5 having the smallest difference in slope as one line segment defining a measurement spot. Note that the line segment L5 is an example of the first line segment. Then, the clearance measurement unit 14 sends information on the line segment L5 at the determined measurement spot to the cross-sectional view creation unit 12.

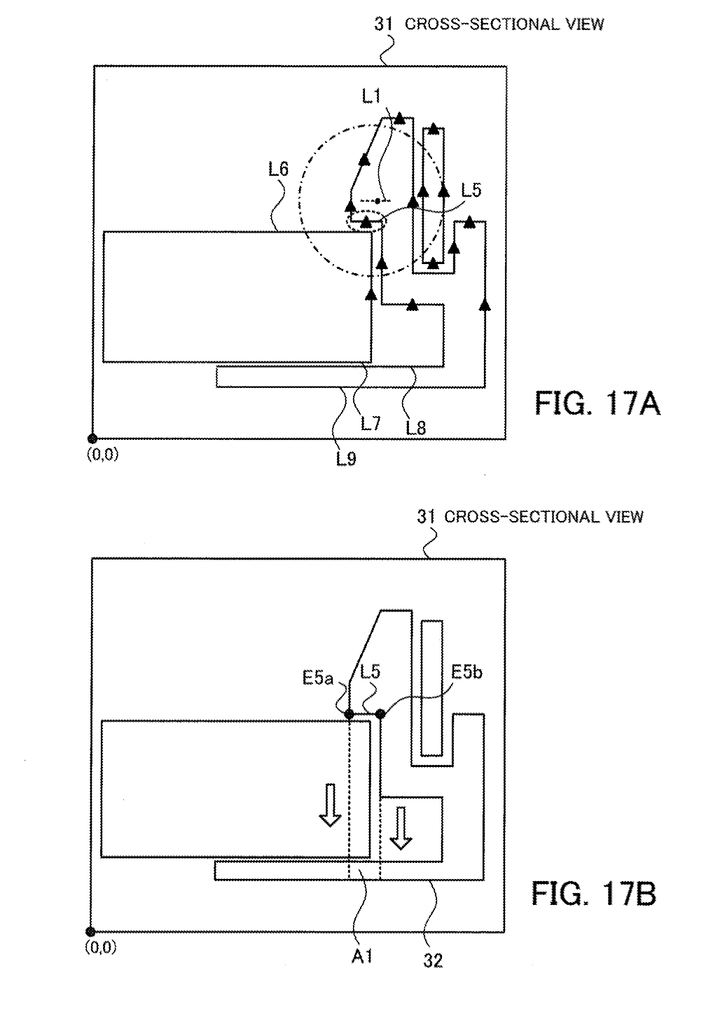

Next, the clearance measurement unit 14 scans the cross-sectional view 31 based on the unit vector V1 included in the measurement spot identification pattern 23a from the line segment L5 at the measurement spot in the direction of the unit vector V1, and determines whether or not an opposed line segment exists. In the illustrated example, as illustrated in FIG. 17A, line segments L6, L7, L8, and L9 exist, and hence the clearance measurement unit 14 identifies a spot for clearance measurement (between line segments) using the following method:

As illustrated in FIG. 17B, the clearance measurement unit 14 sets a rectangle surrounded by the line segment L5, straight lines extending in a direction of measurement from opposite ends E5a and E5b of the line segment L5 at the measurement spot to a maximum outline position 32 of the 3D model 30 in the cross-sectional view 31, and the outline of the 3D model 30, as a clearance measurement range A1.

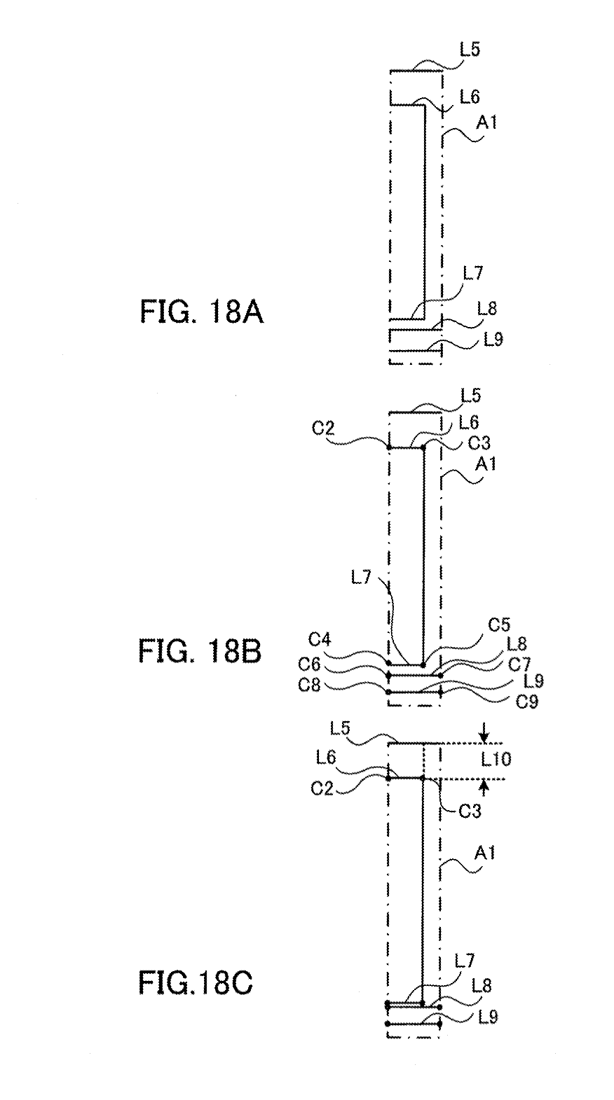

Next, as illustrated in FIG. 18A, the clearance measurement unit 14 extracts all of the line segments L6, L7, L8, and L9 within the clearance measurement range A1.

Next, as illustrated in FIG. 18B, the clearance measurement unit 14 determines the coordinates of each of vertexes C2 to C9 of the extracted line segments L6, L7, L8, and L9 within the clearance measurement range A1.

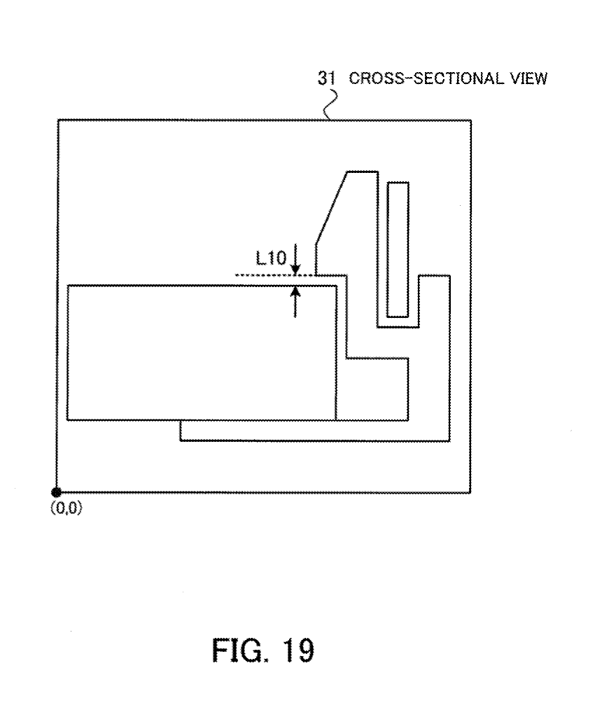

Next, as illustrated in FIG. 18C, the clearance measurement unit 14 identifies a clearance L10 between the line segment L5 and the line segment L6 as a measurement spot, which includes the vertex C2 (or the vertex C3) from which extends the shortest perpendicular line of all perpendicular lines extending from the vertexes C2 to C9 to the line segment L5 at the measurement spot. FIG. 19 illustrates a position of the clearance 10 in the cross-sectional view 31. The clearance measurement unit 14 measures the clearance L10.

The output unit 15 outputs the result of measurement determined by the clearance measurement unit 14.

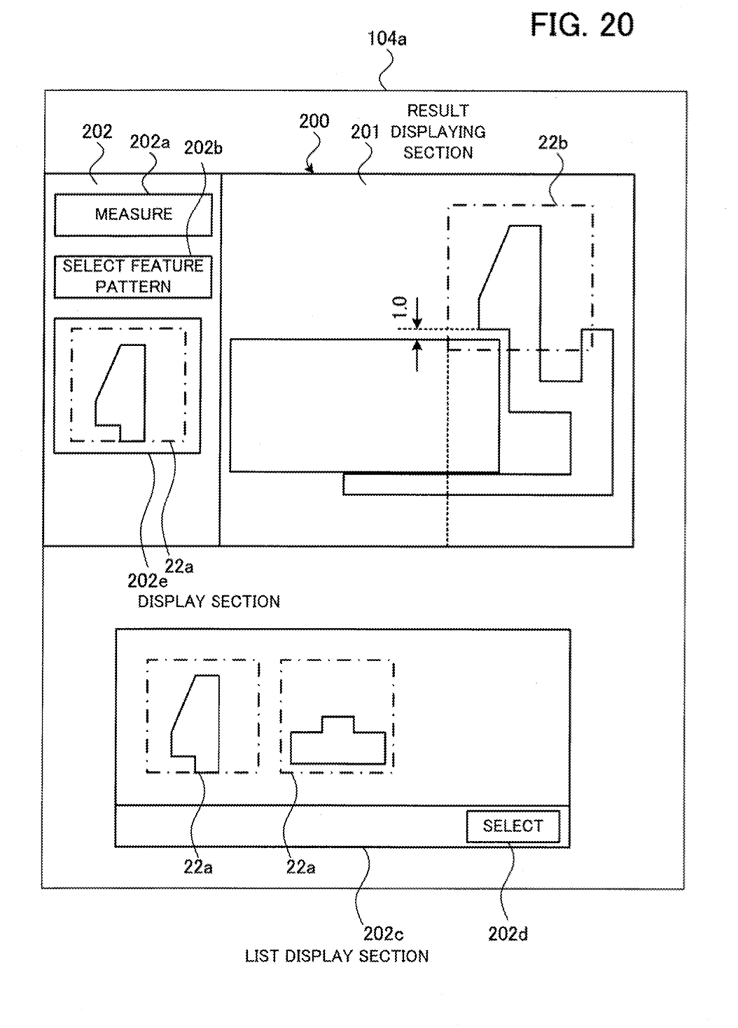

FIG. 20 illustrates an example of the measurement result output from the output unit.

A screen 200 displayed on the monitor 104a includes a result displaying section 201 and a console section 202.

On the result displaying section 201, the measurement result output from the output unit 15 (“1.0” in FIG. 20) is displayed together with the cross-sectional view 31. The output unit 15 may highlight the line segments at the spot for clearance measurement, which is identified by the clearance measurement unit 14.

A measurement button 202a and a feature pattern selection button 202b are displayed on the console section 202. When the designer clicks the feature pattern selection button 202b using e.g. the mouse 105b, the output unit 15 displays a list display section 202c for displaying applicable feature patterns 22a on the monitor 104a. When the designer selects one of the feature patterns 22a from the list display section 202c, and clicks a selection button 202d using e.g. the mouse 105b, the output unit 15 displays the selected feature pattern 22a on a display section 202e.

Further, when the designer clicks the measurement button 202a using e.g. the mouse 105b, the feature part detection unit 13 and the clearance measurement unit 14 operate. Then, the output unit 15 displays the measurement result together with the cross-sectional view 31.

Next, a description will be given of another example of the measurement spot identification process.

<Another Example of the Measurement Spot Identification Process>

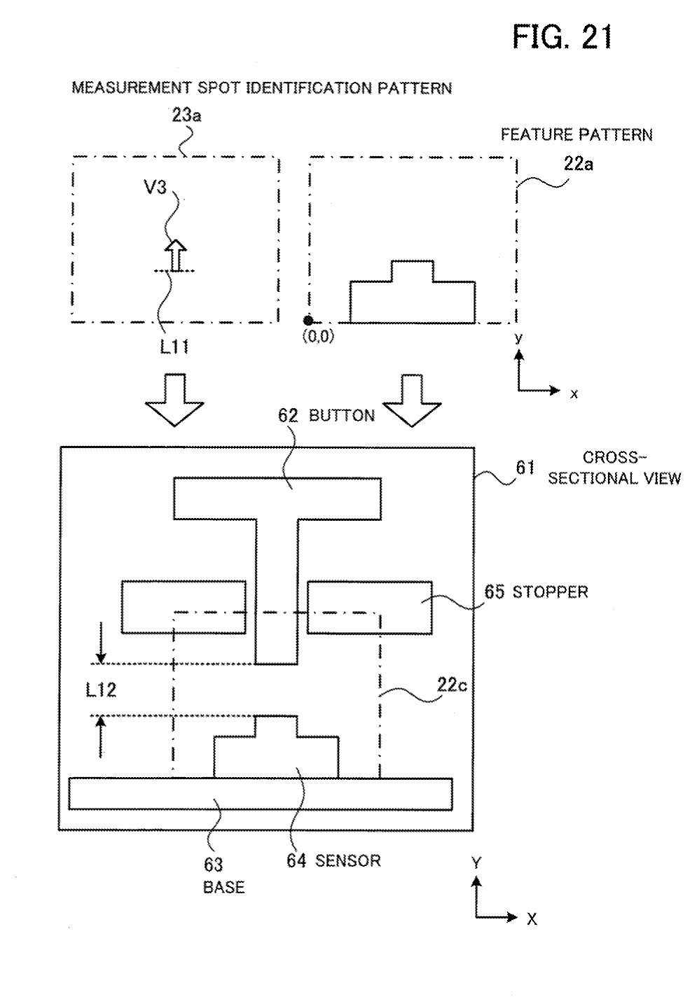

FIG. 21 is a view useful in explaining another example of the measurement spot identification process.

A cross-sectional view 61 illustrated in FIG. 21 illustrates a button 62, a sensor 64 disposed on a base 63, for detecting depression of the button 62, and a stopper 65 with which the button 62 having been depressed is brought into abutment, for thereby restricting the button 62 from moving downward.

FIG. 21 illustrates a part 22c detected on the cross-sectional view 61, which is matched with the feature pattern 22a. By applying the measurement spot identification pattern 23a including a line segment L11 and a unit vector V3 illustrated in FIG. 21, to the part 22c, the clearance measurement unit 14 identifies a clearance L12 between the button 62 and the sensor 64 as a measurement spot.

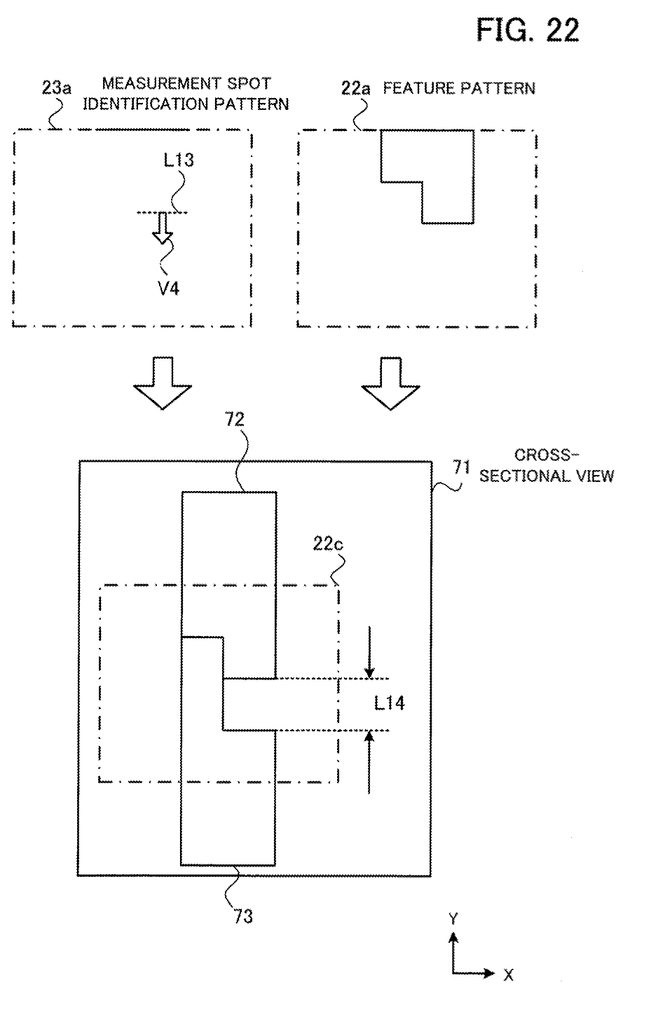

FIG. 22 is a view useful in explaining still another example of the measurement spot identification process.

A cross-sectional view 71 illustrated in FIG. 22 illustrates a component 72 and a component 73. FIG. 22 illustrates a part 22c detected on the cross-sectional view 71, which is matched with the feature pattern 22a. By applying the measurement spot identification pattern 23a including a line segment L13 and a unit vector V4 illustrated in FIG. 22 to the part 22c, the clearance measurement unit 14 identifies a clearance L14 in a recessed butt joint of the component 72 and the component 73 as the measurement spot.

As described above, according to the design support apparatus 10, the clearance measurement unit 14 executes the measurement spot identification process using the measurement spot identification pattern 23a, whereby it is possible to identify the measurement spot.

### (c) Third Embodiment

Next, a description will be given of a design support apparatus according to a third embodiment.

The following description of the design support apparatus according to the third embodiment will be given mainly of the different points from the above described second embodiment, and description of the same component elements as those in the second embodiment is omitted.

The design support apparatus according to the third embodiment is distinguished from that according to the second embodiment in the measurement spot identification process.

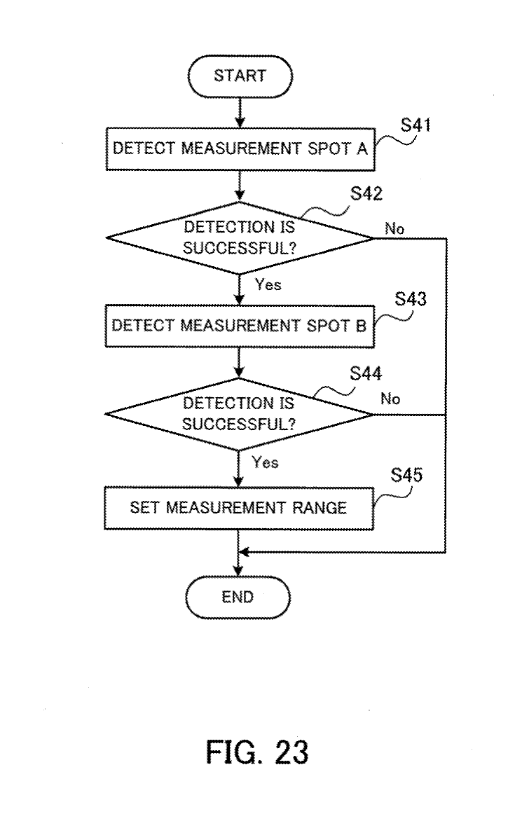

FIG. 23 is a flowchart of the measurement spot identification process according to the third embodiment.

[Step S41] The clearance measurement unit 14 starts identification of a first measurement spot. Then, the process proceeds to a step S42.

[Step S42] The clearance measurement unit 14 determines whether or not the first measurement spot has been identified. If the first measurement spot has been identified (Yes to the step S42), the process proceeds to a step S43. If the first measurement spot has not been identified (No to the step S42), the process in FIG. 23 is terminated.

[Step S43] The clearance measurement unit 14 starts identification of a second measurement spot. Then, the process proceeds to a step S44.

[Step S44] The clearance measurement unit 14 determines whether or not the second measurement spot has been identified. If the second measurement spot has been identified (Yes to the step S44), the process proceeds to a step S45. If the second measurement spot has not been identified (No to the step S44), the process in FIG. 23 is terminated.

[Step S45] The clearance measurement unit 14 sets a measurement range. Then, the process in FIG. 23 is terminated.

Next, a description will be given of an example of the measurement spot identifying process according to the third embodiment.

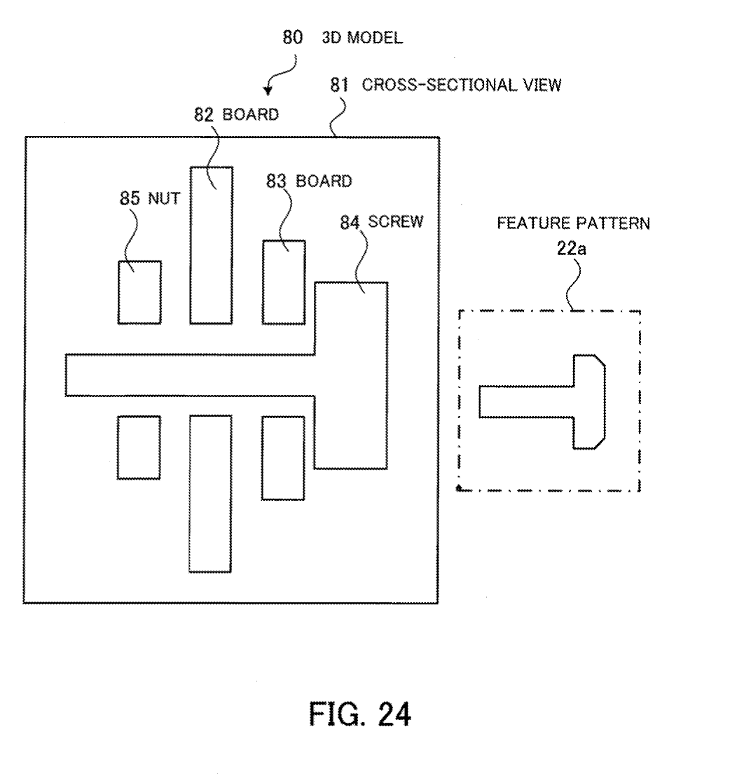

FIGS. 24 to 30 are views useful in explaining the example of the measurement spot identification process according to the third embodiment.

FIG. 24 illustrates a cross-sectional view 81 of a 3D model 80 and a feature pattern 22a according to the third embodiment. The 3D model 80 is a model formed by tightening two boards 82 and 83 with a screw 84 and a nut 85. An approximate location of the screw 84 is detected by referring to the feature pattern 22a by the feature part detection unit 13.

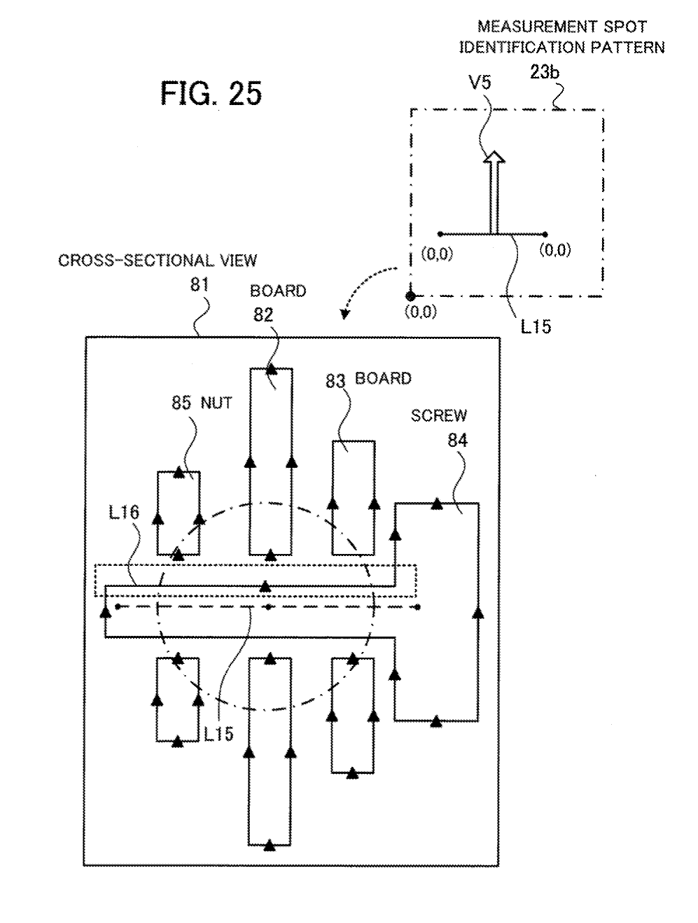

A measurement spot identification pattern 23b illustrated in FIG. 25 includes a line segment L15 serving as a reference and a unit vector V5 which indicates a direction of measurement.

The clearance measurement unit 14 identifies a line segment L16 as a spot for clearance measurement, from the cross-sectional view 81 of the 3D model 80, using the measurement spot identification pattern 23b. The same identification method as that used in the second embodiment is used. That is, the steps S31 to S34 in FIG. 14 are executed.

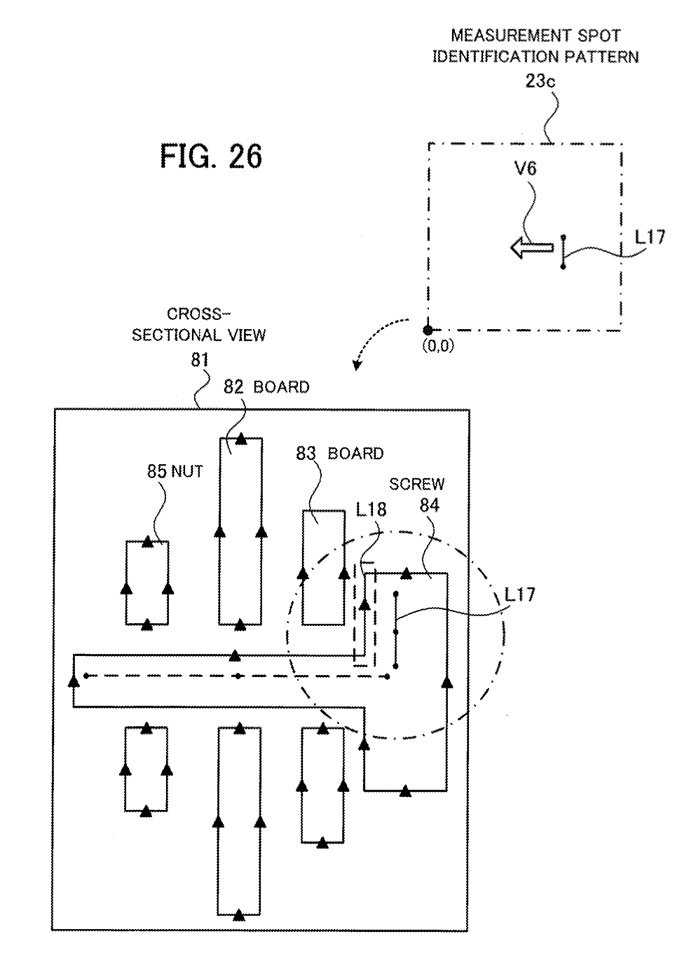

A measurement spot identification pattern 23c illustrated in FIG. 26 includes a line segment L17 serving as a reference and a unit vector (hereinafter referred to as the “measurement range indication vector”) V6 which indicates a measurement range.

The clearance measurement unit 14 identifies a line segment L18 as a spot for clearance measurement, from the cross-sectional view 81 of the 3D model 80, using the measurement spot identification pattern 23c. The same identification method as that used in the second embodiment is used. That is, the steps S31 to S34 in FIG. 14 are executed.

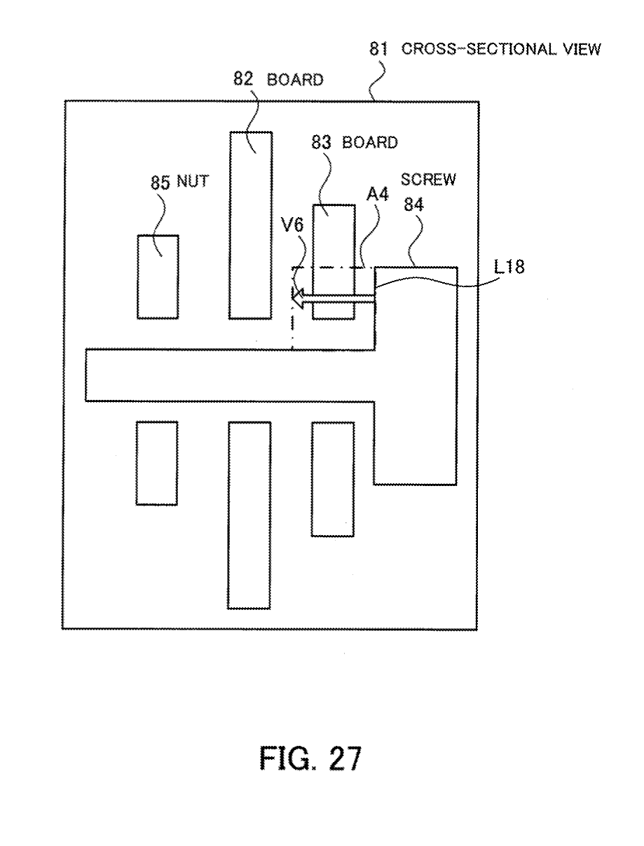

Next, as illustrated in FIG. 27, the clearance measurement unit 14 forms a rectangle corresponding to the magnitude of the unit vector V6 from the line segment L18 in a direction of the unit vector V6 in the measurement spot identification pattern 23c. This rectangle is set as a measurement range A4.

Next, out of the line segments existing from the line segment L16 in the direction of the unit vector V5 in the measurement spot identification pattern 23b, the clearance measurement unit 14 identifies a line segment which is accommodated in the set measurement range A4 and is closest to the line segment L16. More specifically, the following processing is executed:

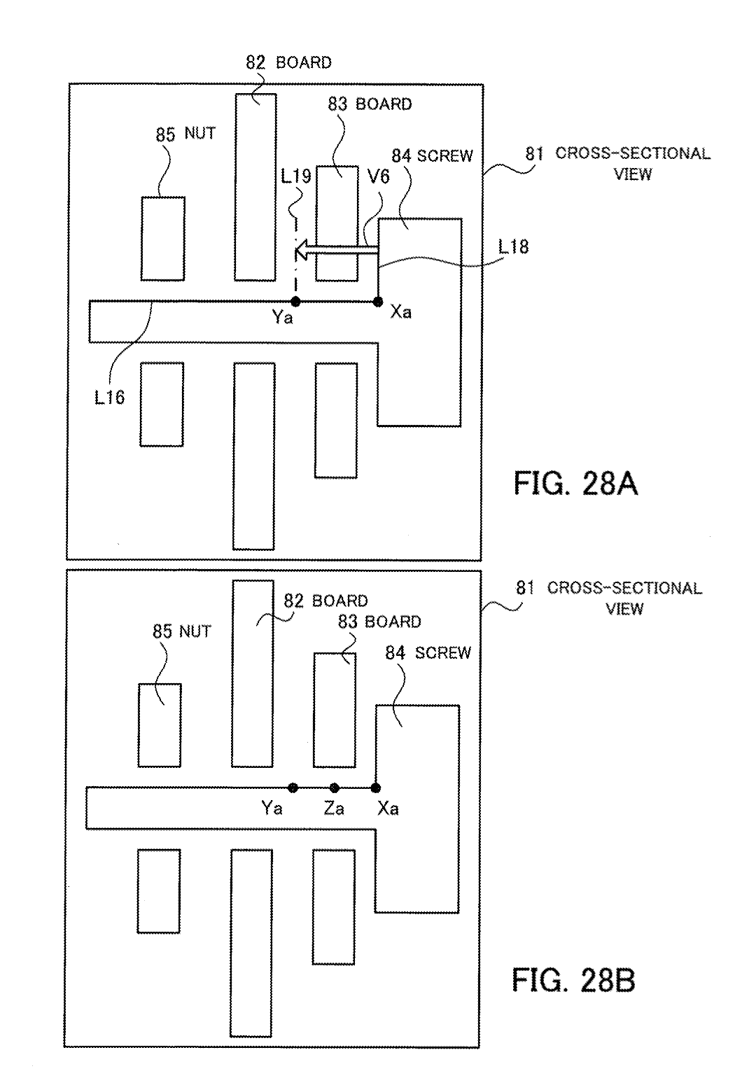

As illustrated in FIG. 28A, the clearance measurement unit 14 calculates an intersection Xa of the line segment L16 and the line segment S18, and an intersection Ya of a straight line L19 formed by offsetting the line segment L18 by the magnitude of the unit vector V6 and the line segment L16. The intersection Xa and the intersection Ya are assumed to be intersections on a straight line having an unlimited length.

Next, as illustrated in FIG. 28B, the clearance measurement unit 14 calculates the center point Za between the intersection Xa and the intersection Ya.

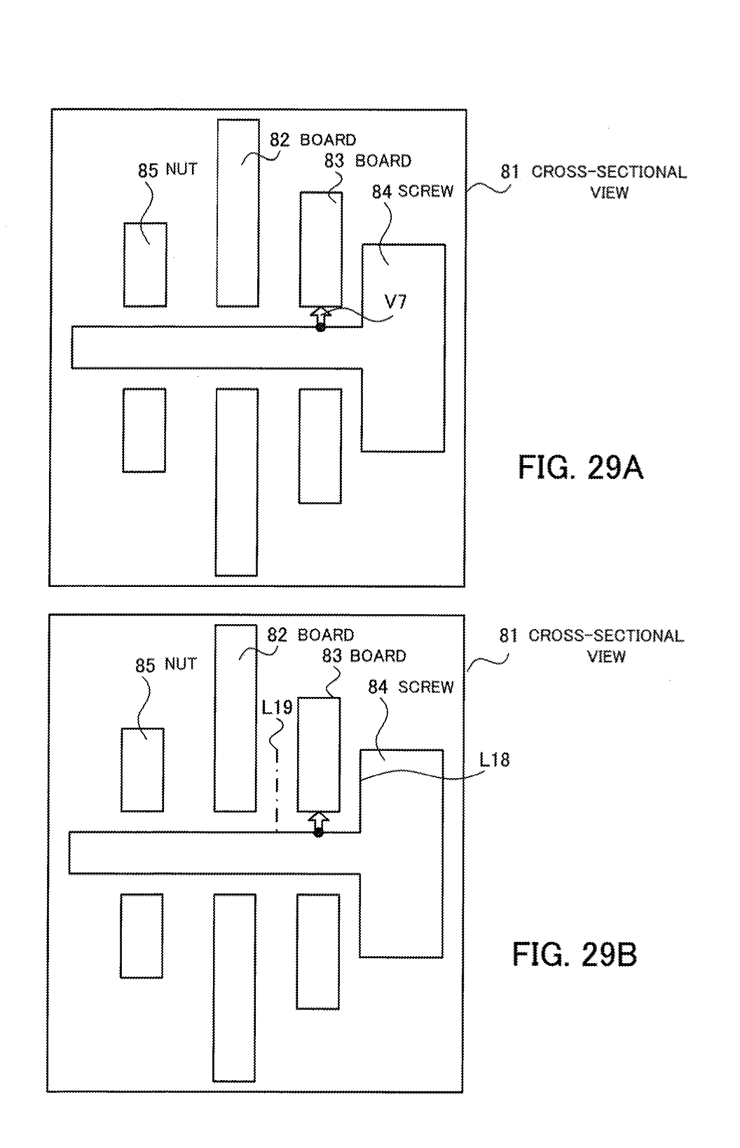

Next, as illustrated in FIG. 29A, the clearance measurement unit 14 disposes a measurement direction indication vector V7 in the same direction as that of the unit vector V5, at a location of the center point Za.

Next, as illustrated in FIG. 29B, the clearance measurement unit 14 identifies a line segment of the measurement spot between the line segment L18 and the straight line L19, using the measurement direction indication vector V7.

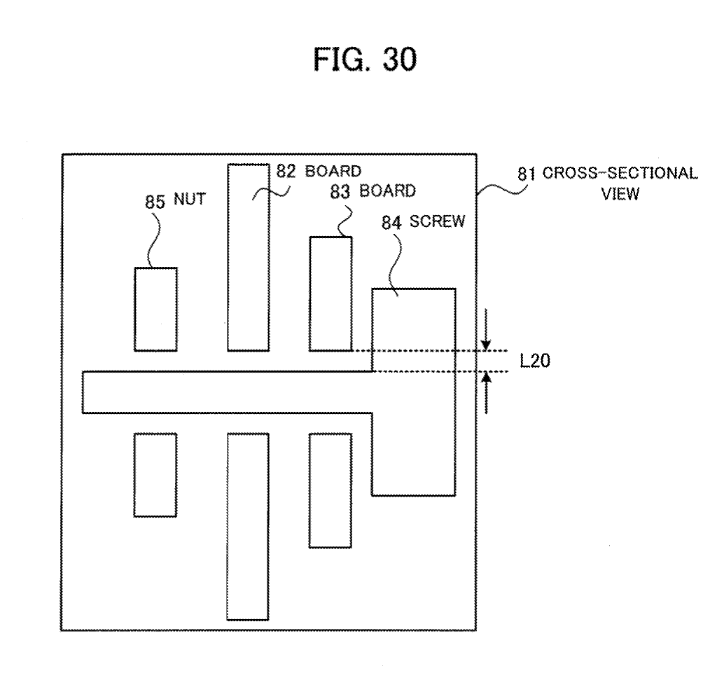

FIG. 30 illustrates the identified measurement spot. The clearance measurement unit 14 measures a clearance L20 of the identified measurement spot.

According to the design support apparatus according to the third embodiment, it is possible to obtain advantageous effects as provided by the design support apparatus according to the second embodiment.

The processes executed by the design support apparatus 10 may be executed by a plurality of apparatuses in a distributed manner. For example, the processes may be executed such that one apparatus executes processing of the feature part detection unit 13 to detect a feature part, and the other apparatus identifies a measurement spot using the feature part.

Note that the processing functions of the above-described embodiments can be realized by a computer. In this case, there is provided a program describing the details of processing of the functions which the design support apparatus 1 or 10 is to have. By executing the program by the computer, the processing functions described above are realized on the computer. The program describing the details of processing can be recorded in a computer-readable storage medium. Examples of the computer-readable record medium include a magnetic recording system, an optical disk, a magnetooptical medium, a semiconductor memory or the like. Examples of the magnetic recording system include a hard disk device (HDD), a flexible disk (FD), a magnetic tape. Examples of the optical disk include a DVD, a DVD-RAM, a CD-ROM/RW. Examples of the magnetooptical medium include an MO (Magneto-Optical disc).

In case of distributing programs, for example, portable recording mediums, such as DVD, CD-ROM or the like in which the program is recorded are marketed. Further, it is also possible to store the program in a storage device of a server computer, and transfer the program from the server computer to the other computer via a network.

The computer which carries out the program stores, for example, the program which is recorded in the portable recording medium, or is transferred from the server computer in the storage device thereof. Then, the computer reads out the program from the storage device thereof, and carries out the processes according to the program. Note that the computer is also capable of directly reading out the program from the portable recording medium, and carrying out the processes according to the program. Further, the computer is also capable of carrying out the processes according to the program which is received, each time the program is transferred from the server computer.

Further, at least part of the processing functions described above is realized by an electronic circuit, such as a DSP (Digital Signal Processor), an ASIC (Application Specific Integrated Circuit), and a PLD (Programmable Logic Device).

It is possible to identify a proper spot for clearance measurement.

All examples and conditional language provided herein are intended for the pedagogical purposes of aiding the reader in understanding the invention and the concepts contributed by the inventor to further the art, and are not to be construed as limitation to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A design support apparatus including a processor configured to execute processing comprising:
determining, using a line segment serving as a reference end points of which are each defined by a relative position to a predetermined shape appearing in a cross-section of an object for which clearance measurement is performed, a line segment which satisfies a predetermined condition in relation to the line segment serving as the reference, out of line segments appearing in a cross-sectional view created based on shape data of the object, as a first line segment including a start point of a spot for clearance measurement; and
identifying, using a vector which specifies a direction of clearance measurement, a clearance between the first line segment determined by said determining and a second line segment existing in a direction of the vector from the first line segment, as a measurement spot.

2. The design support apparatus according to claim 1, wherein said determining sequentially extracts a predetermined number of line segments from the object, in an increasing order of distance from the line segment serving as the reference, and sets a line segment having the smallest difference in slope from the line segment serving as the reference, out of the extracted line segments, as the first line segment.

3. The design support apparatus according to claim 1, wherein when a plurality of line segments exist in the direction of the vector of the first line segment, said identifying determines a line segment which is shortest in length of all perpendicular lines extending from vertexes of the plurality of line segments to the first line segment, as the second line segment.

4. The design support apparatus according to claim 1, wherein said processing further comprises determining a third line segment serving as a start point of a range of clearance measurement using the line segment serving as the reference, and determining the range of clearance measurement using the determined third line segment and a vector specifying a direction of clearance measurement, and
wherein said identifying determines, out of line segments existing in the direction of the vector specifying the direction of clearance measurement from the first line segment, which are determined by said determining using the vector specifying the direction of clearance measurement, a line segment within the range of clearance measurement, as a second line segment.

5. The design support apparatus according to claim 1, wherein said processing further comprises detecting a part having a predetermined shape in each of cross-sections created from a 3D model of the object,
wherein said determining determines the first line segment from the part detected by said detecting.

6. The design support apparatus according to claim 1, wherein the processing further comprises measuring the clearance identified by said identifying.

7. A design support method executed by a processor, comprising:
determining, using a line segment serving as a reference end points of which are each defined by a relative position to a predetermined shape appearing in a cross-section of an object for which clearance measurement is performed, a line segment which satisfies a predetermined condition in relation to the line segment serving as the reference, out of line segments appearing in a cross-sectional view created based on shape data of the object, as a first line segment including a start point of a spot for clearance measurement; and
identifying, using a vector which specifies a direction of clearance measurement, a clearance between the first line segment determined by said determining and a second line segment existing in a direction of the vector from the first line segment, as a measurement spot.

8. A computer-readable storage medium storing a design support program for causing a computer to execute processing comprising:
determining, using a line segment serving as a reference end points of which are each defined by a relative position to a predetermined shape appearing in a cross-section of an object for which clearance measurement is performed, a line segment which satisfies a predetermined condition in relation to the line segment serving as the reference, out of line segments appearing in a cross-sectional view created based on shape data of the object, as a first line segment including a start point of a spot for clearance measurement; and
identifying, using a vector which specifies a direction of clearance measurement, a clearance between the first line segment determined by said determining and a second line segment existing in a direction of the vector from the first line segment, as a measurement spot.
